(19) United States
(12) Patent Application Publication
(10) Pub. No.: US 2026/0192668 A1
(43) Pub. Date: Jul. 9, 2026

(54) Apparatus and Method for Projecting a Racing Line in an Electric Vehicle Heads-Up Display

(71) Applicant: Vincent Loccisano, Wellesley, MA (US)

(72) Inventor: Vincent Loccisano, Wellesley, MA (US)

(21) Appl. No.: 19/555,165

(22) Filed: Mar. 3, 2026

Related U.S. Application Data
(63) Continuation-in-part of application No. 18/783,611, filed on Jul. 25, 2024, now abandoned.

(51) Int. Cl. B60K 35/28; B60K 35/23; B60K 35/65; B60K 35/81; B60R 16/023; B62D 15/02; G06T 11/10; G06V 20/56; G06V 20/58

(52) U.S. Cl. CPC B60K 35/28; B60K 35/23; B60K 35/654; B60K 35/81; B60R 16/0231; B62D 15/029; G06T 11/10; G06V 20/58; G06V 20/588; B60K 2360/166; B60K 2360/178; B60K 2360/188; B60K 2360/21; G06V 2201/08

(57) ABSTRACT

A method and apparatus enables modifying the electronic controls of EVs to mimic the sensory experience of driving a performance ICE race car. The method and apparatus creates a sensory “virtual cockpit” by modifying an EV HUD to mimic that of a performance ICE car customized for racing.

### TECHNICAL FIELD

The present disclosure is an apparatus and method related to methods, circuits, or devices for controlling the electronic visual heads-up display of electrically propelled vehicles to achieve a desired performance; information or communication for improving the operation of electric vehicles. The apparatus and method involves arrangements of instruments for, and display of, information in a vehicle, including non-manual adjustments, e.g. with electrical operation with logic circuits and with logic circuits using sensors or detectors for adapting control systems specially adapted for electric vehicles, and more specifically to systems and methods for calculating an optimal racing line to maximize vehicle speed through a curved path.

### BACKGROUND OF THE INVENTION

While electric vehicles (EVs) and hybrid vehicles offer environmental benefits by reducing greenhouse gas emissions, some drivers find the driving experience to be unsatisfactory because there is little sensory feedback of the kind they are used to in traditional internal-combustion-engine (ICE) vehicles. Some consumers express a preference for the visual experience associated with traditional internal-combustion-engine (ICE) vehicles or ICE vehicles adapted for racing, whether out of nostalgia, a perception of a more engaging driving experience, or lack of feedback about vehicle performance in EVs.

Automobile electronics, including computers, electrical cables, and software protocols, are together known as a Controller Area Network (CAN), or CAN bus. A CAN is a vehicle's main computer system. Through the CAN bus, data travels through the system to the many subsystems such as those controlling the engine, the transmission, doors, windows, and other subsystems. Each of these subsystems is controlled by an electronic control (ECU). Current EVs may have fifty or more ECUs, each able to sense signals indicating, for example: acceleration at various angles; voltage; pressure; braking; vehicle roll and yaw; steering angle; temperature, and other variables. The CAN bus routes signals from sensors to computers as communicated by each ECU. An ECU can monitor voltage used by a subsystem and communicate that information through the CAN bus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development has become physically easier because each new feature can now be added by programming the new computer code into the CAN. Now, all vehicle features as well as vehicle diagnostics are controlled via CAN, which uses a standardized protocol called OBD-II. New features can be integrated into an EV by developing and uploading an algorithm into the vehicle's CAN.

Vehicle computer networks are now evolving to work with other network protocols, including Local Interconnect Networks (LIN) and FlexRay, which are network protocols designed for vehicles, as well as Ethernet.

Modern EV vehicles have software components allowing the suspension, driveline performance, and driver experience to be customizable for a variety of applications. For example, a modern EV may have an “eco” mode that offers greater distance range; a comfort mode that tunes the suspension to be compliant and smooth; and a high-performance mode that offers the best traction, acceleration and cornering performance.

Modern electric drivetrains offer high horsepower and near-instantaneous torque, depending on the size of the car's batteries and number of electric motors. Some EVs have four electric motors, one at each wheel, enabling advanced dynamic control such as torque and power vectoring. Because of this, previously impossible levels of performance, acceleration and speed, as well as control over individual systems, are now available.

The multiple motors of an EV's subsystems enable fine-tuning of vehicle dynamics and performance under braking, acceleration and cornering. Some EVs offer four-wheel steering, with both the front and rear wheels selectively steering in sometimes-different directions. Other controls, including steering ratio, brake-pedal response, accelerator response, horsepower and torque curves are readily changed in a modern EV, simply because they require no more than electronic inputs into the drivetrain and new algorithms downloaded to the vehicle CAN. Shock absorbers and dampers that are electronically controlled can be easily reconfigurable settings. Current computing technology allows implementing variable steering ratios and vehicle performance such as understeer and oversteer.

A Heads-Up Display (HUD) is a transparent image projected onto a windshield of a vehicle that presents data without requiring a driver to look away from the road. The origin of the name HUD stems from its earliest application in aircraft where a transparent display in front of the wind screen enabled easier view. A HUD obviates the necessity of refocusing between the landscape and the near surface of the interior dashboard.

In the context of high-performance driving and autonomous vehicle navigation, the “racing line” is defined as the optimal path around a race circuit that allows a vehicle to complete a lap in the minimum amount of time. Contrary to the shortest distance between two points, the racing line is primarily characterized by the maximization of speed.

The fundamental physical principle governing the racing line is the maximization of the curve's radius. By utilizing the entire width of the available track—typically initiating the turn from the outside edge, clipping an inner point (the apex), and exiting near the outside edge—the vehicle can travel along a path that is effectively “straighter” than the track's physical boundaries. Maximizing the radius minimizes the centripetal acceleration required to negotiate the turn, according to the relationship between cornering force F, mass m, velocity v, and radius r, where (F=mv²/R). Therefore, a larger radius allows for a higher velocity v for a given limit of tire adhesion (cornering force). The braking point is the location on the track where the driver

or system applies deceleration force. The optimal braking point is determined by vehicle-specific factors, such as braking system efficiency, tire friction coefficients, and vehicle behavior under load. the objective of deceleration strategy is to reduce vehicle speed sufficiently to navigate the apex without missing the apex, sometimes referred to as pushing wide or understeer, while avoiding over-deceleration, which necessitates inefficient mid-corner acceleration. Trail Braking is a term that refers to advanced techniques wherein brake pressure is maintained past the turn-in point. This technique shifts vehicle weight to the front tires, reducing understeer and improving directional change during entry.

A turn-in point marks the transition from the braking phase to the cornering phase. The trajectory from the turn-in point is directed toward the apex, which is the geometric point where the vehicle is closest to the inside edge of the corner. Apex selection strategies vary based on the desired outcome. A geometric apex describes a traditional approach where the path maintains a constant radius. This is often used for simple corners to maintain momentum. A late apex strategy shifts the apex further along the corner. By sacrificing entry speed, the vehicle can straighten the exit line earlier, allowing for earlier throttle application and higher acceleration out of the turn. This is generally preferred for maximizing speed on subsequent straightaways.

Following the apex, the steering angle is reduced as the vehicle accelerates toward the outside edge of the track. The calculation of the optimal line is not static; it is heavily influenced by the position and direction of the subsequent corner. For example, an optimal line through one corner may be compromised to facilitate a faster entry into the next. Furthermore, the optimal racing line is dynamic and inextricably linked to environmental and mechanical conditions. It varies based on vehicle handling characteristics (e.g., oversteer vs. understeer), track surface conditions, and, in competitive scenarios, the reactive positioning of other vehicles on the track.

### SUMMARY OF THE INVENTION

A method and apparatus enable modifying the electronic controls of EVs to mimic the sensory experience of driving a performance ICE car. The method and apparatus creates a sensory “virtual cockpit” by modifying an EV HUD to mimic that of a performance ICE car customized for racing. By downloading and implementing the method and apparatus, one may replicate, for example, the HUD style and graphics used in auto racing. These graphics include a racing line denoting the optimal line to drive through a curve while remaining safely within a lane. The racing line may change color to indicate optimal locations for slowing or braking. For example, a yellow racing line may indicate an optimal location to ease off the accelerator, and a red line may indicate an optimal location in which to brake. Traction wheel speeds slippage etc.

Other features of the HUD may project a gauge-indicating traction and general stability by calculating the rpm of each wheel with respect to speed to determine the friction between the tires and the road. A HUD may also project speed, rate of acceleration, distance remaining with current energy level and the like. In some embodiments the HUD is used in conjunction with features to create a virtual experience of driving a performance ICE car, including a tachometer and indicator showing the gear to be used in the ICE at a particular speed. Though not required in an electric motor, such features enhance the experience of driving a performance ICE.

In some embodiments, a software program controls the images projected by a HUD to provide a racing line by receiving information from an EV onboard camera that captures a road ahead of the vehicle. At least one sensor coupled to the vehicle may include a wheel-speed sensor, a speedometer, a GPS signal, a motor-speed sensor, interior temperature sensor, and/or an exterior temperature sensor. A wheel-speed sensor may measure the rotational velocity of each wheel. A speedometer commonly measures the speed of the vehicle over the road. A GPS signal may be used to measure the movement of the vehicle over a mapped area of a road, this result may be compared with information from the speedometer. A motor speed sensor may be used in combination with a wheel-speed sensor, a speedometer and a GPS signal to determine traction or slippage of each wheel. A racing line may be altered to indicate a need for altered steering and braking to indicate an ideal driving line. Images of information gathered from sensors may be projected through the HUD. In some embodiments information gathered from sensors is projected through the HUD, onto the windshield of the vehicle in an image that mimics an image of a related gauge from an ICE performance vehicle. Vehicle speed may be represented by a speedometer from a classic Jaguar vehicle dashboard, for example, or EV voltage may be represented by an ICE performance vehicle gas gauge. Interior or exterior temperature may also be projected through the HUD.

In an example use of the apparatus, a user may upload HUD software to an electric vehicle controller-area network. The software captures an image of the road ahead of the vehicle from at least one onboard camera and also captures information from at least one sensor. The software compiles information from the camera and sensor(s) to define road parameters including speed, traction and slippage of each wheel, and direction of the vehicle. The compiled information informs the generation of an image of a racing line, which may be projected on the EV windshield through a HUD. Information from sensors is further used to calculate optimal turning, braking, acceleration through the racing line and the racing line is so updated with color and intensity to reflect a safe and effective driving line.

In another embodiment, the HUD may additionally identify other vehicles on the same road segment and calculate an ideal passing line around said vehicle(s) wherein the passing line is based on calculations of road condition and vehicle dynamic parameters. Dynamic parameters include predicted vehicle traction, current vehicle traction, available acceleration and driver steering, acceleration and braking parameters. The embodiment effectively calculates a way to pass other vehicles in proximity a driver of the electric vehicle. In a similar manner the HUD may provide notifications of required steering inputs in a graphical manner. For example, an obstacle in the road, captured by the EV onboard camera, may engage the software to project a graphical indication of required steering inputs. Steering inputs include, for example, those that indicate to continue straight, steer slightly left, steer forcefully left, steer slightly right, or steer forcefully right. Similarly notifications of acceleration and deceleration inputs may also be projected in a graphical manner. Acceleration or deceleration inputs may include gradual or immediate acceleration, or gradual or immediate deceleration.

The method and apparatus's algorithm may be downloaded into any of an EV's ECUs, CAN, LIN, or Ethernet platform to simulate aspects of an ICE. The method and apparatus creates a virtual cockpit that simulates a particular ICE vehicle, toggling between an EV and ICE experience.

### BRIEF DESCRIPTION OF DRAWINGS

FIG. 1 is a diagram of an example racing line.

FIG. 2 is a diagram of an example racing line intended for increased speed through a curve.

FIG. 3 is a diagram of an example racing line through a hairpin turn.

FIG. 4 is a perspective view of the interior of an electric vehicle showing a heads-up display graphic on a windshield.

FIG. 5 is a flowchart of a method of the disclosure.

### DETAILED DESCRIPTION

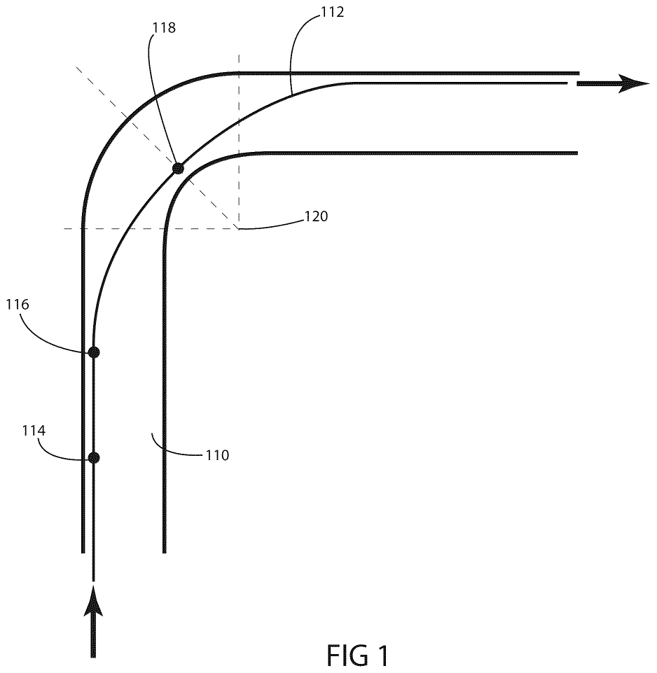

FIG. 1 is a diagram of an example racing line referred to as a traditional racing line. A traditional racing line smooths out the corner and maintains momentum through the corner but does not necessarily yield the fastest possible lap time. An example road 110 has a 90° turn. An apex 118 is located at approximately 45° through the turn. The 90° turn and 45° location of the apex 118 is depicted by dashed lines 120. An example of a traditional path 112 through a turn includes a wide approach 114 that is followed by the beginning of the turn 116 to the apex 118 to a wide exit.

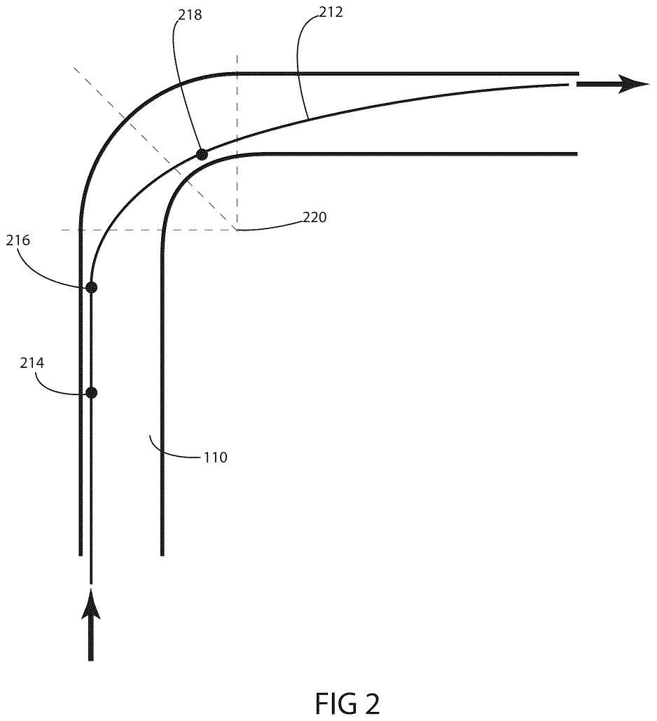

FIG. 2 demonstrates a more aggressive path 212 through a similar corner to that of FIG. 1, The corner is approximately 90° with an apex 218 that is past the 45° point in the corner, shown by the dashed lines 220, in a track 210. Although this example may not be the highest average speed around the corner it tends to yield a faster lap time. The path 212 begins with a wide approach 214 that is followed by the beginning of the turn 116 to a relatively later apex 218 that leads to a longer, straighter exit toward the straight portion exiting the corner. This allows for greater acceleration at the exit of the corner than seen in the example of FIG. 1. This approach commonly requires training as the apex is not in view as a driver approaches the corner.

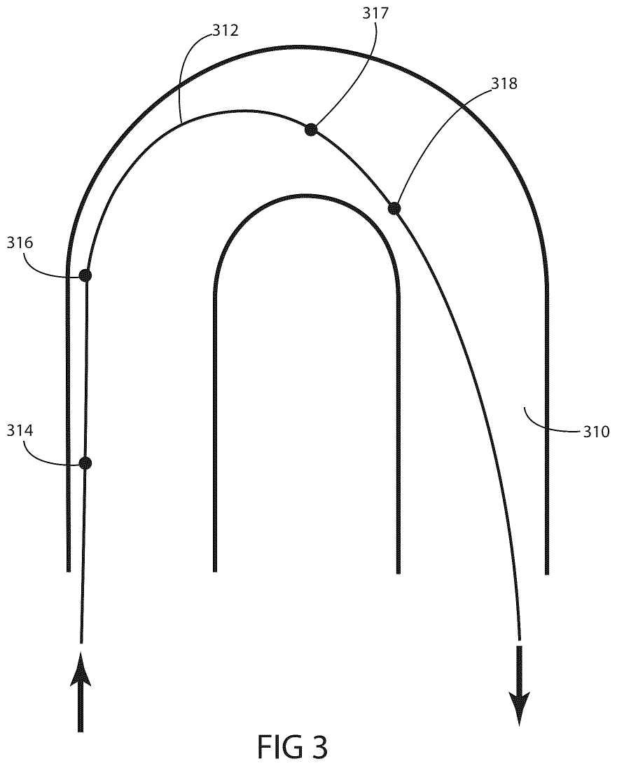

FIG. 3 is an example of a racing line 312 through a 180° curve on a track 310. The racing line 312 begins with a wide approach 214 followed by the beginning of the turn 316 and reaches the middle of the track 317 halfway through the 180° curve. The apex 318 is considerably late in the curve allowing for relatively greater acceleration along the straight portion exiting the curve.

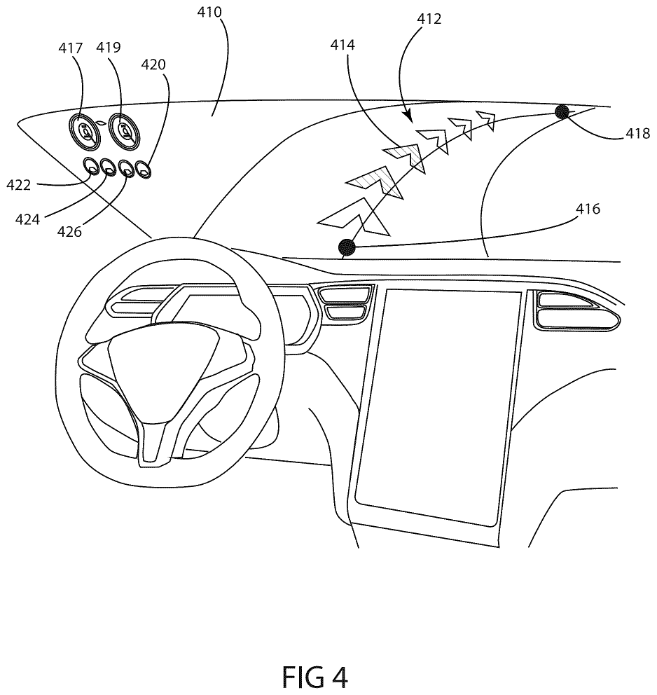

FIG. 4 is a perspective view of the interior of an electric vehicle showing heads-up display graphics on a windshield 410. A racing line 412 is based on driver inputs related to driver experience, vehicle handling characteristics, track surface conditions, and the reactive positioning of other vehicles on the track. The racing graphic line may change color 414 to indicate optimal locations for slowing or braking. For example, a yellow segment of a racing line may indicate an optimal location to ease off the accelerator, and a red line segment may indicate an optimal location to brake. The type of racing line (FIGS. 1-3) may also be indicated by graphic characteristics. Color changes or line markers may indicate the approach, beginning of the curve 416, apex 418 and exit of the racing line (FIGS. 1-3).

In some embodiments a software program is configured to gather information from EV onboard cameras and sensors to derive information which is projected through the HUD onto the windshield 410 in the style and graphics used in auto racing. For example, a performance ICE vehicle speedometer 417 may depict an animated moving needle showing vehicle speed in MPG or KmPH.

Additional information common to performance ICE vehicles configured for racing may also be projected. In an example embodiment, traction is measured by wheel sensors and projected 420. One skilled in the art understands that current EV onboard computers are capable of measuring wheel RPM and calculating circumference distance vs. speed to determine whether wheels are slipping. In another example, energy level 422 may be projected in a graphic style that mimics a performance ICE-vehicle gas gauge. In another example, images of gauges like those in performance ICE vehicles may display rate of acceleration, outside temperature, tire pressure and other metrics in place of an ICE oil-pressure gauge or water-temperature gauge. One skilled in the art understands that the gauges may be reassigned as an EV does not have oil or water coolant to measure.

In another example an ICE-style tachometer 419 is projected through the HUD. Although there is no need for a tachometer 419 in an EV, one skilled in the art understands that the tachometer may show an increase up to a given speed normally associated with first gear, and then a decrease followed by an increase up to a given speed normally associated with second gear, and so on. In yet other embodiments, ICE engine, turbocharger and transmission sounds are played through the EV sound system following the movement of the tachometer.

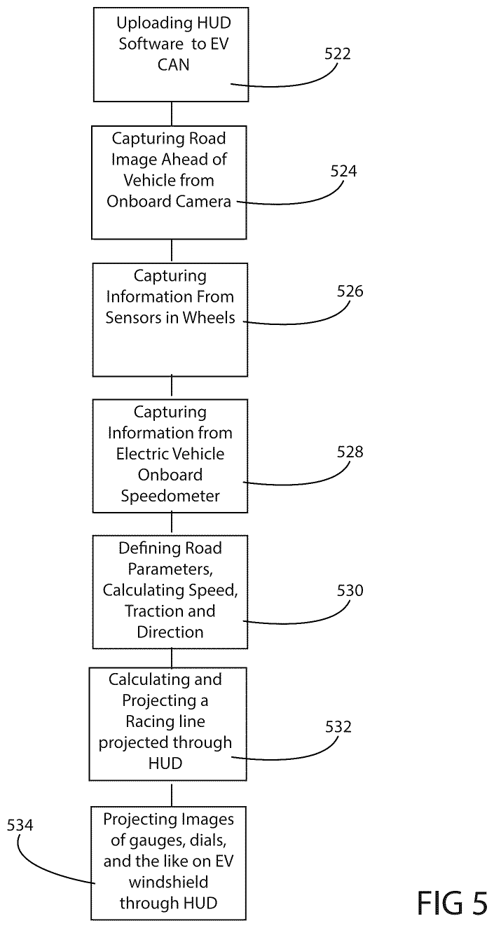

FIG. 5 is a schematic of the method of the disclosure. A software program configured to interface with EV onboard cameras and sensors is uploaded to the EV CAN 522 and directs the EV HUD. The software captures a road image from the EV onboard camera 524. Sensors proximal to the wheels of the EV measure rotational velocity of each wheel 526. The speed of the vehicle is measured by the EV onboard speedometer 528. The information gathered and measured is used to calculate speed, traction and direction 530. One skilled in the art understands that the rotational velocity of each wheel, the direction of the vehicle and the direction of a turn in the road may be used to calculate the traction, or slippage, of each wheel. The information gathered is used to inform the software program which then calculates a racing line along the road ahead and projects the racing line 532 on the EV windshield through the heads-up display.

Images of gauges, dials, and the like are projected on the EV windshield through the EV HUD 534. In some embodiments the gauges, dials and the like are rendered images of gauges and dials from ICE performance-vehicle dashboards.

1. A system for enhancing the driver interface of an electric vehicle, comprising:
a heads-up display configured to project images onto a windshield of the vehicle; and
at least one onboard camera; and
a plurality of sensors configured to measure wheel rotation and vehicle speed;
a processor in communication with the HUD, the camera, and the plurality of sensors via a vehicle network protocol; and
a memory storing instructions that, when executed by the processor, cause the processor to:
analyze a road path captured by the camera; and
calculate real-time traction limits based on data from the plurality of sensors; and
generate a racing line graphic representing an optimal trajectory through the road path; and
display the racing line graphic on the heads-up-display.

2. The system of claim 1 wherein:
the racing line graphic is dynamically updated to change color in response to the calculated real-time traction limits and curve geometry to indicate an optimal braking point for an upcoming curve.

3. The system of claim 1 wherein:
the instructions further cause the processor to detect an obstacle in the road path via the camera; and
project a graphical indication of a required steering input onto the HUD to navigate around the obstacle.

4. The system of claim 1 wherein:
the graphical indication of the required steering input specifies a direction and a force level, ranging from a slight steering input to a forceful steering input.

5. A method for providing a virtual racing interface in an electric vehicle, comprising:
receiving via a controller area network (CAN) of the electric vehicle, image data from at least one onboard camera capturing a road segment ahead of the vehicle; and
receiving sensor data from a plurality of sensors, the sensor data including at least wheel-speed data and vehicle speed data; and
calculating via an electronic control unit (ECU), vehicle dynamic parameters including traction and slippage for each wheel of the electric vehicle based on the sensor data; and
determining an optimal racing line for the road segment based on the image data and the calculated vehicle dynamic parameters; and
projecting a graphical representation of the optimal racing line onto a heads-up display of the electric vehicle, wherein the graphical representation is overlaid on a driver's view of the road segment.

6. The method of claim 5 wherein:
the graphical representation of the optimal racing line comprises a plurality of color-coded segments indicating required driver inputs, including:
a first color indicating an optimal location to cease acceleration; and
a second color indicating an optimal location to apply braking force.

7. The method of claim 5 wherein:
determining the optimal racing line includes selecting an apex strategy from the group consisting of a geometric apex and a late apex based on a detected curvature of the road segment.

8. The method of claim 5 further comprising:
identifying at least one second vehicle in proximity to the electric vehicle via the image data; and
calculating an ideal passing line based on the position of the second vehicle and predicted vehicle traction; and
projecting the ideal passing line onto the heads-up-display.

9. The method of claim 5 wherein:
the plurality of sensors further comprises at least one of a GPS receiver, a motor-speed sensor, and an exterior temperature sensor.

10. A non-transitory computer-readable medium comprising instructions that, when executed by a vehicle control system, perform the steps of:
receiving environmental data from a vehicle camera and movement data from vehicle sensors; and
calculating an optimal racing line for a curved path based on the environmental data and current tire adhesion limits derived from the movement data; and
projecting the optimal racing line onto a heads-up display (HUD) such that the line is visually aligned with the curved path from a driver's perspective.
